(19) United States
(12) Patent Application Publication
(10) Pub. No.: US 2025/0243003 A1
(43) Pub. Date: Jul. 31, 2025

(54) AUTOMATED LUGGAGE STORAGE SYSTEM AND METHOD FOR OPTIMIZING IDLE SPACE

(71) Applicant: Noblestorage Co., Ltd., Gyeonggi-do (KR)

(72) Inventor: Woojae JEONG, Gyeonggi-do (KR)

(73) Assignee: Noblestorage Co., Ltd., Gyeonggi-do (KR)

(21) Appl. No.: 18/963,909

(22) Filed: Nov. 29, 2024

(30) Foreign Application Priority Data
Jan. 30, 2024 (KR) 10-2024-0014392
Nov. 26, 2024 (KR) 10-2024-0171304

(51) Int. Cl. B65G 1/137; B65G 1/04

(52) U.S. Cl. CPC B65G 1/137; B65G 1/0478

(57) ABSTRACT

An automated cargo storage apparatus includes a cargo storage part including a plurality of storage spaces arranged in a plurality of layers, each of the layers being divided into the plurality of storage spaces, each occupying a predetermined area on a plane along a rail arranged in a grid structure, a cargo entry/exit part protruding outward from one side of the cargo storage part and having an elevator structure that moves a cargo storage cage vertically through a plurality of support plates that are movable upward or downward in the elevator structure, the cargo storage cage being loaded or unloaded through the cargo entry/exit part, and a control part configured to move a target cargo storage cage to a storage space at a desired (specified) location and control vertical movement of the plurality of support plates within the cargo entry/exit part.

### CROSS-REFERENCE TO RELATED APPLICATION

This application claims priorities to and the benefits of Korean Patent Application No. 10-2024-0014392, filed on Jan. 30, 2024, and Korean Patent Application No. 10-2024-0171304, filed on Nov. 26, 2024 the disclosure of which is incorporated herein by reference in its entirety.

### BACKGROUND

### 1. Field of the Invention

Various embodiments of the present disclosure relate to an automated cargo storage apparatus and method for minimizing idle space.

### 2. Discussion of Related Art

Recently, with the explosive expansion of the e-commerce market, the number of logistics warehouses has increased worldwide, and various types of logistics systems related to fulfillment warehouses, led by Amazon, have been developed. However, while technological development is being optimized for small, diverse-product (delivery systems), pallet-based large-scale storage technologies using forklifts remains relatively undeveloped.

In addition, with the recent increase in overseas business trips, travel, exchange student programs, and working holidays, people are faced with situations in which they need to leave their homes, and in apartments and small living spaces, it is difficult to store large or unnecessary items. In addition, there is a growing tendency for people to look for places in which to safely store items from which they are also easily accessible when needed.

In this regard, conventional cargo storage systems have taken the form of simple lockers for storing cargo for a short time, or taken the form of more systematic cargo storage warehouses to store cargo for long periods of time, and cargo is stored in a designated space within the cargo storage warehouse and managed.

In this case, a space in which cargo is stored may not be occupied by other cargo, and cargo is placed in empty spaces in the warehouse using a device of transportation, such as a forklift. For example, when all spaces are full of cargo, other cargo may need to be placed on a different layer using a device of transportation such as a forklift.

As described above, the conventional cargo storage system not only uses a device of transportation such as a forklift, but also places cargo mainly in empty spaces as a temporary measure, rather than systematically placing cargo, which leads to various constraints when the cargo is unloaded, and requires space for a device of transportation, such as the forklift, to move, and in which case it is impossible to place cargo on a high floor using a forklift. Furthermore, when cargo is received and unloaded using a forklift, many accidents occur due to the forklift.

Accordingly, there is a need to develop an automated cargo storage apparatus that does use a forklift and systematically and efficiently receives and unloaded cargo in an automated manner without idle space even in a large area.

### RELATED ART DOCUMENTS

### Patent Document

Korean Registered Patent No. 10-1671745 (Registered date: Oct. 27, 2016)

### SUMMARY OF THE INVENTION

The present disclosure is directed to providing an automated cargo storage apparatus and method for minimizing idle space, in which, in order to position a received cargo storage cage carrying cargo at a desired location in a grid-structured storage space, another cargo storage cage that has already been placed and serves as an obstacle is freely moved to the location of another storage space using a cargo entry/exit part and a storage space in front of the entry/exit part.

The present disclosure is directed to providing an automated cargo storage apparatus and method for minimizing idle space, in which, in order to unload a cargo storage cage located at an arbitrary location in a grid-structured storage space, another cargo storage cage that has already been placed and serves as an obstacle is freely moved to the location of another storage space using a cargo entry/exit part and a storage space in front of the cargo entry/exit part.

The technical objectives of the present disclosure are not limited to the above, and may be variously expanded without departing from the technical concept and field of the present disclosure.

According to an aspect of the present disclosure, an automated cargo storage apparatus includes a cargo storage part including a plurality of storage spaces arranged in a plurality of layers, each of the layers being divided into the plurality of storage spaces, each occupying a predetermined area on a plane along a rail arranged in a grid structure, a plurality of cargo storage cages loaded with cargo being placed in the plurality of storage spaces and movable forward, backward, leftward, and rightward along the rail, respectively, a cargo entry/exit part protruding outward from one side of the cargo storage part and having an elevator structure that moves a cargo storage cage vertically in the elevator structure, the cargo storage cage being loaded or unloaded through the cargo entry/exit part, and a control part that moves a target cargo storage cage to a storage space at a desired (specified) location and controls vertical movement of the cargo storage cage within the cargo entry/exit part, wherein the cargo entry/exit part includes one more layer than a number of the layers in the cargo storage part, and the control part may, when unloading a first cargo storage cage located in a target layer, temporarily move a second cargo storage cage, placed in an adjacent storage space in the target layer, to an upper layer to create an empty storage space in the target layer, sequentially move the plurality of cargo storage cages in the target layer to position the first cargo storage cage in the storage space previously occupied by the second cargo storage cage, and unload the first cargo storage cage through the cargo entry/exit part.

In an embodiment, the control part may, when moving a targeted cargo storage cage to a desired location, repeatedly perform a process of moving the plurality of cargo storage cages to create an empty storage space in an adjacent storage space in a movement direction of the targeted cargo storage cage, and moving the target cargo storage cage into the empty storage space.

In an embodiment, the control part may, when moving the targeted cargo storage cage to the desired location, select a looped multiple storage spaces including a current location, the desired location, and the empty storage space, and sequentially moves the cargo storage cages located in the plurality of storage spaces to the looped multiple storage spaces to position the targeted cargo storage cage to the desired location.

In an embodiment, the selected multiple storage spaces may be selected to have a minimum movement path from the current location of the targeted cargo storage cage to the desired location.

In an embodiment, the selected multiple storage spaces may be selected based on weights of cargos loaded in the plurality of cargo storage cages respectively placed in the plurality of storage spaces.

In an embodiment, the rail may include a plurality of rotatable rollers to enable the cargo storage cages to move forward, backward, leftward, and rightward, and the control part may control rotation of the plurality of rollers to control the movement of the targeted cargo storage cage.

In an embodiment, the cargo storage cages may include a plurality of rotatable rollers to enable forward and backward and left and right movement to enable the cargo storage cages to move along the rail.

In an embodiment, the cargo entry/exit part may include a plurality of elevator parts that are movable upward or downward while carrying the cargo storage, and the plurality of elevator parts may be maintained while being stacked on the ground in an area where a cargo storage cage is loaded and unloaded. An upper elevator part, loaded with the second cargo storage cage, moves vertically to provide a movement space within the cargo entry/exit part, and a lower elevator part moves through the movement space to transport the first cargo storage cage to an entry/exit area.

In an embodiment, the plurality of elevator parts may respectively include rails connected to a rail formed in the cargo storage part and connected to a rail extending to outside through an entry/exit area.

In an embodiment, each of the plurality of storage spaces may be fully occupied by the cargo storage cages, and during entry of a cargo storage cage, an empty cargo storage cage is preemptively unloaded to create an empty storage space.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic exemplary view illustrating the entire configuration of an automated cargo storage system according to an embodiment of the present disclosure;

FIG. 2 is a schematic view illustrating a configuration of an automated cargo storage apparatus according to an embodiment of the present disclosure;

FIG. 3 is a schematic top view illustrating a cargo storage part and a cargo entry/exit part of an automated cargo storage apparatus according to an embodiment of the present disclosure;

FIG. 4 is a schematic front view illustrating some parts of a cargo storage part according to an embodiment of the present disclosure;

FIG. 5 is a schematic exemplary view illustrating a cargo storage cage in a cargo storage part according to an embodiment of the present disclosure;

FIG. 6 and FIG. 7 are diagrams illustrating a state of a cargo storage cage being moved from an arbitrary location to another location during entry and exit of a cargo storage cage according to an embodiment of the present disclosure;

FIG. 8 is a diagram illustrating a state of a cargo storage cage that is an object of movement being moved in consideration of the weight of cargo according to an embodiment of the present disclosure;

FIG. 9 is a diagram illustrating a process of determining the location of a cargo storage cage loaded with cargo in consideration of the temperature according to an embodiment of the present disclosure; and

FIG. 10 is a schematic exemplary diagram illustrating the shape of a multi-layered storage space and a cargo entry/exit part according to an embodiment of the present disclosure.

### DETAILED DESCRIPTION OF EXEMPLARY EMBODIMENTS

While embodiments according to the concept of the present disclosure are subject to various modifications and alternative forms, specific embodiments thereof are shown by way of example in the accompanying drawings and will herein be described in detail. However, it should be understood that there is no intent to limit the present disclosure to the particular forms disclosed, rather the present disclosure is to cover all modifications, equivalents, and alternatives falling within the spirit and scope of the present disclosure. In description of the drawings, like numerals refer to like elements.

In the present specification, “unit” includes a unit realized by hardware, a unit realized by software, and a unit realized using both. Further, one unit may be realized by using two or more pieces of hardware, or two or more units may be realized by one piece of hardware. It should, however, be understood that the term “unit” is not limited to a software or hardware element. A “unit” may be implemented in addressable storage media. A “unit” may also be configured to reproduce one or more processors. For example, a “unit” may include various types of elements (e.g., software elements, object-oriented software elements, class elements, task elements, etc.), segments (e.g., processes, functions, attributes, procedures, sub-routines, program code, etc.), drivers, firmware, micro-code, circuits, data, databases, data structures, tables, arrays, variables, etc. Functions provided by elements and “units” may be formed by combining them into a smaller number of elements and “units” or may be divided into additional elements and “units.” In addition, elements and “units” may also be implemented to reproduce one or more CPUs in devices or security multi-cards.

The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof.

Terms such as “first,” “second,” etc. are used to distinguish one element from another and do not modify the elements in other aspects (e.g., importance or sequence).

Terms used herein are used for describing particular embodiments and are not intended to limit the scope and spirit of the present disclosure. It should be understood that the singular forms “a” and “an” also include the plural forms unless the context clearly dictates otherwise. Terms (including technical and scientific terms) used herein have the same meaning as commonly understood by those of ordinary skill in the art to which the present disclosure belongs. It will be further understood that terms, such as those defined in commonly used dictionaries, should be interpreted as having meanings that are identical or similar to their meanings in the context of the relevant art and will not be interpreted in an idealized or overly formal sense unless expressly so defined herein. In some cases, even terms defined in the present disclosure cannot be construed to exclude embodiments of the present disclosure.

Hereinafter, exemplary embodiments will be described in detail with reference to the accompanying diagrams.

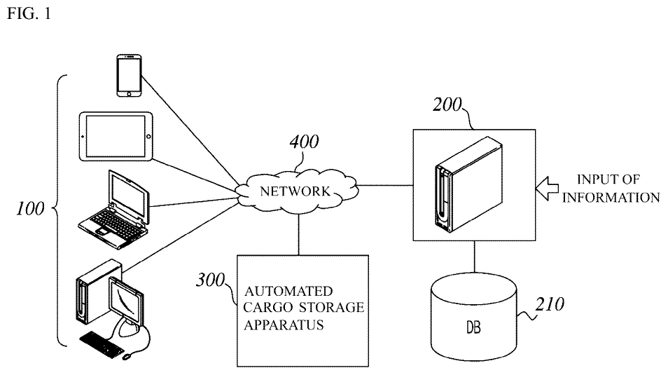

FIG. 1 is a schematic exemplary view illustrating the entire configuration of an automated cargo storage system according to an embodiment of the present disclosure.

Referring to FIG. 1, an automated cargo storage system according to an embodiment may include a user terminal 100, an entry/exit management apparatus 200, an automated cargo storage apparatus 300, and a network 400.

In an embodiment, the user terminal 100 is a terminal used to request storage of a user's cargo for a long or short period of time to the entry/exit management apparatus 200 connected to the network 400, and retrieve the stored cargo.

In this case, the user may input personal information as well as cargo information, storage period information, and cargo weight information into the user terminal 100 to request storage of user's cargo from the entry/exit management apparatus 200.

Here, the personal information may be information required to verify the identity of the user who wishes to store cargo, and may also be information used for membership registration. On the other hand, the cargo information and the storage period information may be information required for cargo storage in practice.

Therefore, the user terminal 100 may generate a cargo storage request message including at least one of personal information, cargo information, storage period information, and cargo weight information input by the user and transmit the cargo storage request message to the entry/exit management apparatus 200 through the network 400.

The user terminal 100 may, upon receiving a cargo storage completion message corresponding to the cargo storage request message from the entry/exit management apparatus 200, identify that the user's cargo storage has been performed normally.

In this case, the cargo storage completion message may be a message including at least one of a management number assigned to the cargo, a user name, cargo storage status information, and storage cost information. However, the above information included in the cargo storage request message and the cargo storage completion message is only an example, and various other types of information may be included.

Accordingly, when the user terminal 100 receives the cargo storage completion message from the entry/exit management apparatus 200, the user terminal 100 may process a cost processing process related to cargo storage in cooperation with the entry/exit management apparatus 200. Since the cost processing processor is generally well known, details thereof will be omitted.

In addition, when it is the cargo storage completion date or when the user desires to retrieve the cargo within a specified period of time, different from a designated cargo storage period, the user terminal 100 may further generate a storage cargo withdrawal request message input by the user and transmit the storage cargo withdrawal request message to the entry/exit management apparatus 200.

Therefore, the entry/exit management apparatus 200 may withdraw a corresponding cargo storage cage stored in the automated cargo storage apparatus 300 in response to the storage cargo withdrawal request message being input by the user and hand the cargo storage cage over to the user, and may check whether there is an additional cost for the cargo storage cage stored during the time and proceed with cost settlement processing in cooperation with the user terminal 100, and may summarize the results of the processing and transmit a storage cargo withdrawal completion message to the user terminal 100.

As described above, in the present embodiment, a series of processes from the start of cargo storage to the completion of cargo storage may be performed through the user terminal 100 and the entry/exit management apparatus 200.

Meanwhile, the user terminal 100 described above may be at least one of a personal computer (PC; for example, a desktop computer, a laptop or notebook computer, a tablet computer, and the like), a smart phone (for example, iOS, Android, Windows Phone, and the like), a mobile phone or feature phone, a smart TV capable of connecting to the Internet, a wearable device, an Internet of Things (IoT) device, and a browser device capable of processing a unique function, but is not limited thereto.

In an embodiment, the entry/exit management apparatus 200 may not only generate the cargo storage completion message, the cost processing process, and the storage cargo withdrawal completion message described above, but also perform a series of processes for storing a cargo storage cage, of which storage is requested by the user, in a certain storage space of the automated cargo storage apparatus 300 and unloading the stored cargo storage cage in a certain method in practice.

For example, the entry/exit management apparatus 200 may receive information on the type of cargo, a management number, and a location of an arbitrarily designated storage space for the cargo from the manager, generate a storage request message including such information, and transmit the storage request message to the automated cargo storage apparatus 300 via the network 400.

However, the present disclosure is not limited thereto. For example, the entry/exit management apparatus 200 may not transmit the location information of the storage space designated by the manager to the automated cargo storage apparatus 300, but may transmit a storage request message including only basic information, such as the type of cargo to be stored and the management number, to the automated cargo storage apparatus 300 via the network 400.

In this case, the automated cargo storage apparatus 300 may move a cargo storage cage to a designated (desired) arbitrary storage space, which is designated based on its own algorithm, and store the cargo storage cage and then transmit a storage completion message to the entry/exit management apparatus 200.

In addition, the entry/exit management apparatus 200 may transmit an exit request message for unloading the corresponding cargo storage cage according to the user's request to the automated cargo storage apparatus 300 through the network 400 to withdraw the corresponding cargo, and may receive an unloading completion message regarding the cargo storage cage unloaded from the automated cargo storage apparatus 300, and may transmit a cargo withdrawal completion message corresponding to the unloading completion message to the user terminal 100 through the network 400.

Such an entry/exit management apparatus 200 may be provided in the form of a web page or an app application such that the user may conveniently proceed with the entire process from storing to withdrawing the corresponding cargo, and it is preferable that the entry/exit management apparatus 200 be a server system for managing the form of a web page or an app application.

The server system may be composed of at least one of an app server (a web server), an application server, a database server, a cache server, a message queue server, and a settlement processing server. However, it is not limited to such a configuration of a server system.

In this case, the user terminal 100 may download a web page or an app application and input the information as described above to proceed with the storage and withdrawal of the corresponding cargo.

However, the entry/exit management apparatus 200 may not be a server system, but may take the form of an entry/exit interface terminal that is connected only to the automated cargo storage apparatus 300 through a network without being connected to the user terminal 100.

In this case, the user may transmit information related to the cargo storage and withdrawal process to the manager, and then the manager may directly input the information into the entry/exit management apparatus 200 to proceed with the process of storing and withdrawing the cargo desired by the user.

Meanwhile, the entry/exit management apparatus 200 may include a database 210 to store the data that it processes, and the database 210 may store the corresponding data by a command of the entry/exit management apparatus 200 such that the manager may manage personal information for each user, the status of cargo storage, the status of entry/exit, and the like through the data stored in the database 210.

To this end, the database 210 may be composed of a collection of structured information used to retrieve, manage, and manipulate the stored corresponding data, and for example, may store data in a table constructed in a tabular form, and may provide a query language, such as structured query language (SQL) used to retrieve, modify, delete, and insert data, and may play a role in supporting the manager in accessing the data at the same time to help data to be structured and consistent.

The database 210 may be composed of various types such as a relational database (e.g., MySQL, PostgreSQL, Oracle, and SQL Server), a NoSQL database (e.g., MongoDB and Cassandra), a graph database (e.g., Neo4j), etc., but is not limited thereto.

In an embodiment, the automated cargo storage apparatus 300 may, in response to a storage request message from the entry/exit management apparatus 200, move a cargo storage cage loaded with (carrying) corresponding cargo to the location of a designated (desired) storage space and store the corresponding cargo, and transmit a storage completion message generated as a result thereof to the entry/exit management apparatus 200.

In addition, the automated cargo storage apparatus 300 may, in response to an exit request message requested from the entry/exit management apparatus 200, move a cargo storage cage carrying corresponding cargo from a storage space in which the cargo storage cage is stored to the exit side and unload the corresponding cargo storage cage, and then transmit an unloading completion message generated as a result thereof to the entry/exit management apparatus 200.

As described above, the automated cargo storage apparatus 300 may perform a series of processes for loading or unloading a cargo storage cage. The automated cargo storage apparatus 300 will be described in more detail below.

In an embodiment, the network 400 may be, for example, a wired communication network or a wireless communication network that may exchange data between the user terminal 100 and the entry/exit management apparatus 200.

In the case of a wireless communication network, for example, the network 400 may include at least one of Long-Term Evolution (LTE), LTE Advanced (LTE-A), code division multiple access (CDMA), wideband CDMA (WCDMA), Universal Mobile Telecommunications System (UMTS), Wireless Broadband (WiBro), wireless fidelity (WiFi), wireless Internet, and a global navigation satellite system (GNSS).

In addition, in the case of a wired communication network, the network 400 may include at least one of a local area network (LAN), a wide area network (WAN), a wired Internet network, and a telephone network.

In addition, the network 400 may be, for example, a wired communication network that may exchange data between the entry/exit management apparatus 200 and the automated cargo storage apparatus 300. In this case, the wired communication network may include at least one of a Universal Serial Bus (USB), a High Definition Multimedia Interface (HDMI), Recommended Standard (RS)-232, a LAN, a WAN, an Internet network, and a telephone network.

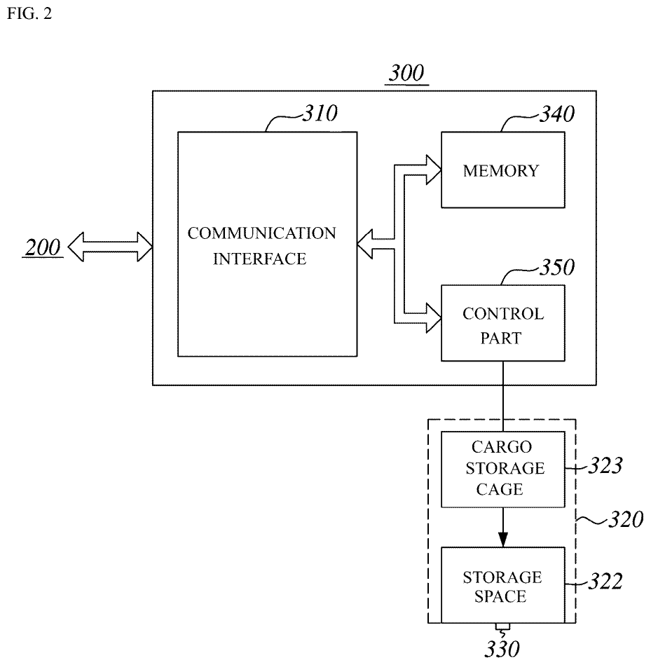

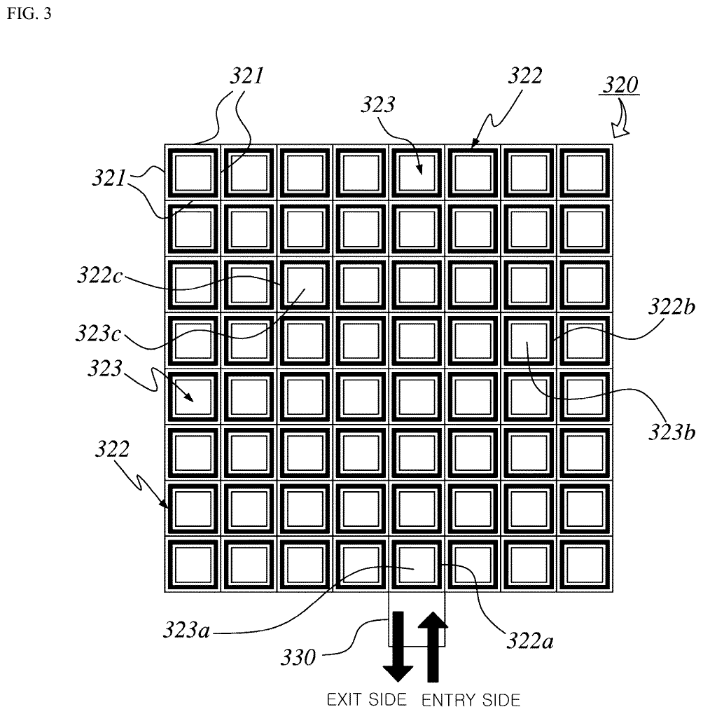

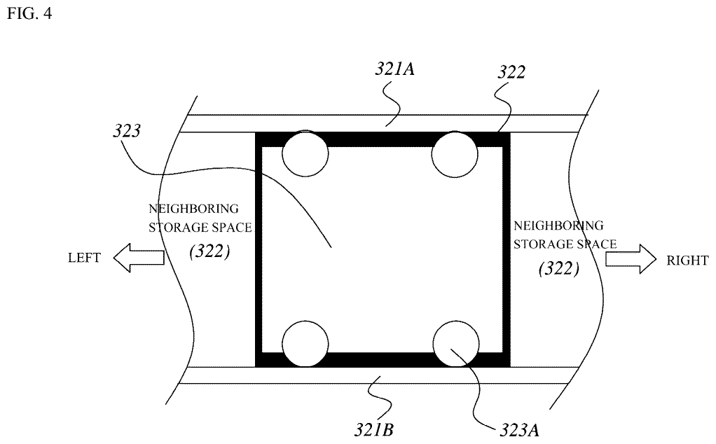

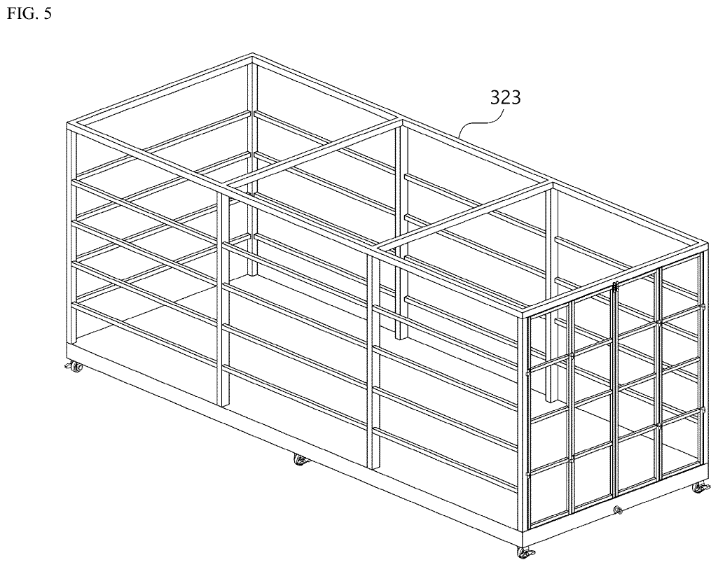

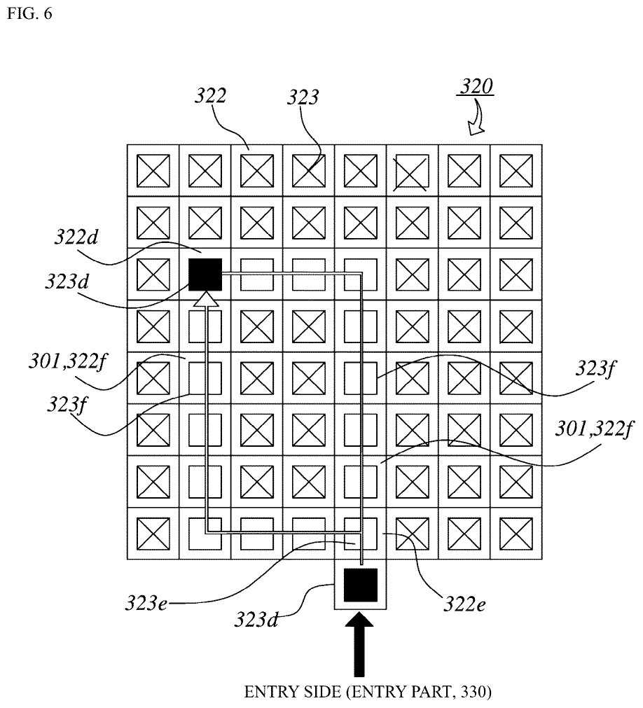

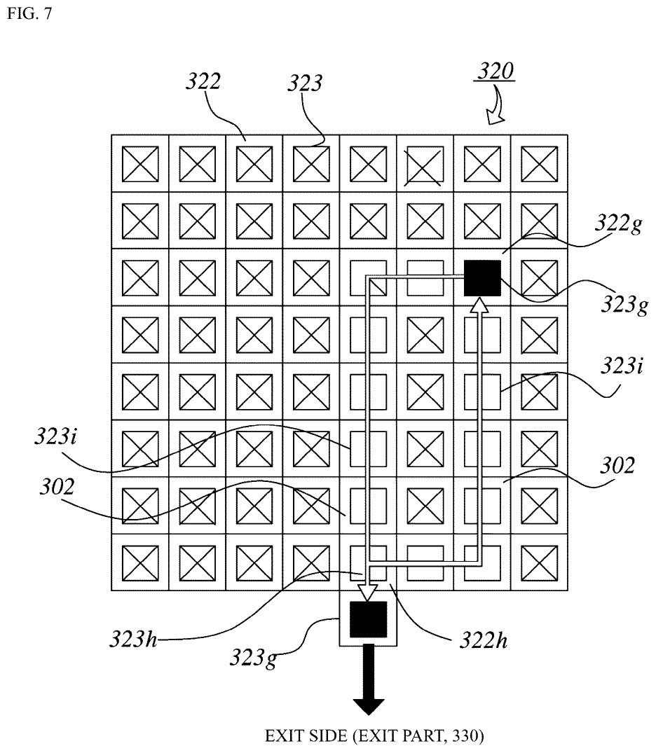

FIG. 2 is a schematic view illustrating a configuration of an automated cargo storage apparatus according to an embodiment of the present disclosure, FIG. 3 is a schematic top view illustrating a cargo storage part and a cargo entry/exit part of an automated cargo storage apparatus according to an embodiment of the present disclosure, FIG. 4 is a schematic front view illustrating some parts of a cargo storage part according to an embodiment of the present disclosure, FIG. 5 is a schematic exemplary view illustrating a cargo storage cage of a cargo storage part according to an embodiment of the present disclosure, and FIG. 6 and FIG. 7 are diagrams illustrating a state of a cargo storage cage being moved from an arbitrary location to another location during entry and exit according to an embodiment of the present disclosure.

In this case, FIGS. 4 to 7 are referred to as supplementary references when describing FIGS. 2 and 3, and the structures of a rail of a grid-like structure 321, a plurality of storage spaces 322, and a plurality of cargo storage cages 323 of a cargo storage part 320 illustrated in FIG. 3 are distinctively indicated to be different from the actual structural formations.

Referring to FIGS. 2 and 3, the automated cargo storage apparatus 300 according to an embodiment may include a communication interface 310, a cargo storage part 320, a cargo entry/exit part 330, a memory 340, and a control part 350.

In an embodiment, the communication interface 310 may provide a communication function to receive corresponding data from the entry/exit management apparatus 200 through the network 400, and transmit data processed by the control part 350 to the entry/exit management apparatus 200 when needed.

In an embodiment, the cargo storage part 320 may form a plurality of storage spaces 322 divided with a certain area on a plane along a rail formed of a grid-like structure 321, as shown in FIG. 3. Furthermore, the cargo storage part 320 includes a plurality of storage spaces 322 arranged in multiple layers.

The rails arranged in the grid-like structure 321 illustrated in FIG. 3 shows only the upper part, but referring to FIG. 4, rails with the same grid-like structure 321 may include an upper rail 321A and a lower rail 321B.

Furthermore, as shown in FIG. 4, the cargo storage part 320 may place the plurality of cargo storage cages 323 that are each arranged in a corresponding one of the plurality of storage spaces 322 and may be movable forward, backward, leftward, and rightward along the upper and lower rails 321. In this case, the plurality of cargo storage cages 323 are shelves (racks) that may load each piece of cargo, including wheels (rollers) 323A that contact the upper and lower rails 321A and 321B, and only the cargo storage cage 323 loaded with the corresponding cargo may be placed in the corresponding storage space 322.

In other words, the cargo storage cage 323 may include a plurality of rotatable rollers to enable forward and backward and left and right movement to enable the cargo storage cages to move along the rail.

FIG. 5 illustrates an example of a cargo storage cage 323. A plurality of rollers are installed on the bottom of the cargo storage cage 323. In FIG. 5, the cargo storage cage 323 has a rectangular parallelepiped shape, but the embodiment is not limited thereto. The cargo storage cage 323 may have a cubic shape but may also take any shape apparent to those skilled in the art.

For example, when there are 64 partitioned storage spaces 322, theoretically, 64 cargo storage cages 323 each loaded with cargo may be placed in the 64 partitioned storage spaces 322.

That is, the plurality of cargo storage cages 323 each loaded with cargo may be respectively placed in the plurality of storage spaces, and may be movable forward, backward, leftward, and rightward along the upper and lower rails 321.

Here, the plurality of storage spaces 322 are multiple partitioned spaces, and thus may be referred to as a matrix structure. For example, assuming storage spaces 322 of 8 rows by 8 columns as shown in FIG. 3, there may be 64 partitioned storage spaces 322. Therefore, theoretically, 64 cargo storage cages 323 each loaded with cargo may be moved and placed within the 64 partitioned storage spaces 322.

However, in practice, the 64 partitioned storage spaces 322 are not occupied by the 64 cargo storage cages 323 moved along the grid-shaped upper and lower rails 321. This is because there are pre-placed cargo storage cages 323 that serve as obstacles for an arbitrary cargo storage cage 323 to move to an empty storage space 322, which prevent 64 cargo storage cages 323 from being received and placed. In addition, since a cargo storage cage 323 already placed in an arbitrary storage space 322 also has neighboring cargo storage cages 323 that are already placed and serve as obstacles, the cargo storage cages 323 may not be unloaded to an exit side.

Therefore, in the present embodiment, instead of filling all the storage spaces 322 with cargo storage cages 323, at least one of the storage spaces 322 may be kept empty without a cargo storage cage 323 and used as a movement path. This is achieved by the cargo entry/exit part 330 to be described below. In this case, the movement path may be configured in various forms, which will be described below.

Meanwhile, although not shown in FIG. 3, the cargo storage part 320 described above may be configured in a plurality of layers. In FIG. 3, only the first layer structure among the plurality of layers is shown as an example.

Moreover, the cargo storage cage 323 of the cargo storage part 320 may have a different shape from the structure of the cargo storage cage 323 of FIGS. 4 and 5 described above. In FIGS. 4 and 5, the cargo storage cage 323 has the wheel structure 323A.

On the other hand, when a plurality of rotatable rollers (or wheels) are installed on the rails 321A and 321B to enable forward, backward, leftward, and rightward movement of the cargo storage cage 323, the cargo storage cage 323 has a “C”-shaped track structure (not shown) that enables the cargo storage cage 323 to move forward, backward, leftward, and rightward on the rollers installed on the rails 321A and 321B.

In this case, the movement control of the cargo storage cage 323 by controlling the rotation of the plurality of rollers may be performed by the control part 350 described below. In addition, the cargo storage cage 323 may further include the same structure as the above-described track structure on the upper part thereof.

That is, the rails 321A and 321B may include a plurality of rotatable rollers to enable the cargo storage cages to move forward, backward, leftward, and rightward. The control part 350 may control rotation of the plurality of rollers included in the rails 321A and 321B to control the movement of the targeted cargo storage cage.

In an embodiment, the cargo entry/exit part 330 may include a cargo entry part required for receiving cargo and a cargo exit part required for unloading a cargo storage cage, and may be arranged adjacent to a storage space 322a located approximately in the center of the plurality of cargo storage spaces 322, as shown in FIG. 3.

The cargo entry/exit part 330 may protrude outward from one side of the cargo storage part 320, such that during entry of a cargo storage cage, an empty cargo storage cage 323a arranged in an adjacent storage space 322a may be moved to and placed in the cargo entry/exit part 330. The location of a storage space 322a that is unoccupied by such a specific cargo storage cage 323a will be referred to as “idle space.”

The cargo entry/exit part 330 may have one more layer than the number of plurality of layers of the cargo storage part 320. Furthermore, the cargo entry/exit part 330 may have an elevator structure capable of moving vertically across the plurality of layers of the cargo storage part 320.

In other words, the cargo entry/exit part 330 may have an elevator structure that moves the cargo storage unit up and down through a plurality of elevator parts that are movable vertically. In this case, the plurality of elevator parts may be implemented with a plurality of support plates. Naturally, any configuration of the plurality of elevator parts that is apparent to those skilled in the art is also possible.

Furthermore, the cargo entry/exit part 330 may be configured to temporarily move a cargo storage cage disposed in the storage area at a certain location to another layer for storage as needed via the elevator structure.

To this end, the cargo entry/exit part 330 may include a plurality of elevator parts for moving the cargo storage part. Also, the cargo entry/exit part 330 may include a driving part capable of moving the plurality of elevator parts vertically.

Each of the plurality of elevator parts may have a rail that is connectable to the rail of the cargo storage part 320. When one of the plurality of elevator parts in the cargo entry/exit part 330 is positioned at one of the plurality of layers of the cargo storage part, the rail formed in the elevator part may be aligned with the rail formed in the cargo storage part 320. The rail formed in the elevator part may connect to a rail that extends outward through the entry/exit area.

As a result, the cargo storage cage located in the cargo storage part may be easily transferred to the cargo entry/exit part 330. In other words, each elevator part may include a rail that connects to the rail of the cargo storage part 320 and to the rail that extend outward through the entry/exit area.

The plurality of elevator parts may be stacked on the ground in the area where a cargo storage cage is loaded and unloaded. Each elevator part may transport a cargo storage cage between the layers.

The cargo entry/exit part 330 provides a movement space for the plurality of elevator parts, and at least one of plurality of elevator parts may move through the movement space to the area where the cargo storage cage is loaded or unloaded.

The plurality of elevator parts may be maintained while being stacked on the ground in the area where a cargo storage cage is loaded and unloaded. Each of the plurality of elevator parts may be moved vertically while being loaded with a cargo storage cage.

The cargo entry/exit part 330 may provide a movement space for the plurality of elevator parts, and at least one of the plurality of elevator parts may be moved through the movement space to the area where a cargo storage cage is loaded and unloaded.

In addition, the cargo entry/exit part 330 may receive a targeted cargo storage cage 323b, which has been already placed in a storage space 322b at an arbitrary location among the plurality of storage spaces 322, that is moved under the control of the control part 350 to be described below. In this case, the target cargo storage cage may be a cargo storage cage that the user has requested for unloading.

Here, during entry of a cargo storage cage, a process of moving a corresponding cargo storage cage 323 located at the entry side of the cargo entry/exit part 330 to the location of a designated (desired) arbitrary storage space 322c or moving a corresponding cargo storage cage 323b in a designated storage space 322c to the location on the exit side of the cargo entry/exit part 330 may be realized by the control part 350 described below.

The cargo entry/exit part 330 may be referred to as a cargo entry part when the cargo is received, and may be referred to as a cargo exit part when the cargo storage cage is unloaded, and may preferably have an elevator structure (not shown) that allows for up and down movement of the cargo storage cage 323. In this case, up and down refers to, for example, the 2nd floor and the 1st floor, and the structures shown in FIG. 3 may represent structures formed on the 1st floor.

In an embodiment, the memory 340 may be a read-only memory (ROM) or a random access memory (RAM) that may temporarily or permanently store data processed by the control part 350 below.

The control part 350 may move a targeted cargo storage cage of the plurality of cargo storage cages disposed in the cargo storage part 320 to a storage space at a desired (specified) location. To this end, the control part 350 may vertically move the plurality of elevator parts of the cargo entry/exit part 330 along the layers. In this case, the control part 350 may control a driving part that drives the plurality of elevator parts up and down.

Specifically, when unloading a first cargo storage cage located in a target layer, the control part 350 may temporarily move a second cargo storage cage, placed in an adjacent storage space in the target layer, to an upper layer by loading the second cargo storage cage onto one elevator part to create an empty storage space in the target layer.

Thereafter, the control part 350 may sequentially move the plurality of cargo storage cages in the target layer to position the first cargo storage cage in the storage space previously occupied by the second cargo storage cage, and load the first cargo storage cage onto another elevator part for unloading.

In an embodiment, in order to control the movement of each cargo storage cage 323, when the rail 321 is provided with a plurality of rollers that are rotatable to allow forward, backward, left, and right movement of the cargo storage cage 323, the control part 350 may control the rotation of the plurality of rollers to control the movement of the cargo storage cage 323 as described above.

Moreover, the control part 350 may control the movement of an arbitrary cargo storage cage 323 located at the location of the cargo entry/exit part 330 to an arbitrary storage space 322, and may control the movement of the cargo storage cage 323 located at an arbitrary storage space 322 to another location, for example, the location of the cargo entry/exit part 330. As described above, the control part 350 may also control the movement of each of the plurality of cargo storage cages 323 to be placed in the plurality of storage spaces 322.

For example, the control part 350 may control a corresponding cargo storage cage 323 such that the cargo storage cage 323 loaded with cargo is moved to the storage space 322 at a desired location through the cargo entry/exit part 330 during entry of a cargo storage cage, and the cargo storage cage 323 placed in the storage space 322 at an arbitrary location is moved to the cargo entry/exit part 340.

In this case, the control part 350 is preferably connected to the corresponding cargo storage cage 323 via wireless short-range communication to control the movement of the corresponding cargo storage cage 323 during entry or exit of a cargo storage cage.

The wireless short-range communication described above may be any one of Bluetooth, Zigbee, Wi-Fi, Near Field Communication (NFC), Radio-Frequency Identification (RFID), Z-Wave, Long Range (LoRa), and Ultra-Wideband (UWB) methods.

As shown in FIG. 6, when moving a targeted cargo storage cage 323d at the location of the cargo entry/exit part 330 to the location of a desired (designated) storage space 322d during entry of a cargo storage cage, the control part 350 may move a cargo storage cage 323e in a storage space 322e adjacent to the cargo entry/exit part 330 to the cargo entry/exit part 330, form idle space 301, which is unoccupied by a cargo storage cage 323f, in a plurality of storage spaces 322f including the adjacent storage space 322e present between the storage space 322d at the designated location and the location of the cargo entry part 330, and further, form the idle space 301 in the storage space 322d at the designated (desired) location such that the targeted cargo storage cage 323d may be moved from the location of the cargo entry/exit part 330 to the designated storage space 322d along a path (an arrow direction) of the idle space 301 selected from among the plurality of idle spaces 301.

Here, the plurality of storage spaces 322 that are targeted for the idle space may be selected based on the minimum path (an arrow direction, a shortest path) from the current location of the targeted cargo storage cage 323d to the desired location.

The minimum path referred to here is the shortest path among various paths present between the location of the cargo entry/exit part 330 and the designated storage space 322, that may be the shortest path among various paths required for the corresponding cargo storage cage 323d on the entry side of the cargo entry/exit part 330 to move to the location of the targeted storage space 322d, which is the destination, and may also be a path along which the corresponding cargo storage cage 323f in the idle space may be moved to the neighboring location at the shortest distance.

In FIG. 6, assuming the worst case that all the storage spaces 322 in one layer of the cargo storage part 320, are filled with cargo storage cages 323, that is, assuming that all the cargo storage cages are placed in multiple storage spaces on one layer of the cargo storage part 330, when loading cargo, a predetermined cargo storage cage may be unloaded in advance to form an empty storage space. In this case, it is preferable that the predetermined cargo storage cage is empty.

Furthermore, when moving the targeted cargo storage cage to the desired location, the control part 350 may select a looped multiple storage spaces including a current location, the desired location, and the empty storage space, and sequentially move the cargo storage cages located in the plurality of storage spaces to the looped multiple storage spaces to position the targeted cargo storage cage to the desired location. The looped multiple storage spaces may refer to a structure in which multiple storage spaces are interconnected, enabling cargo storage cages within these spaces to move in a continuous circular path.

In this case, the selected multiple storage spaces may be selected to have a minimum movement path from the current location of the targeted cargo storage cage to the desired location. Furthermore, the selected multiple storage spaces may be selected based on weights of cargos loaded in the plurality of cargo storage cages respectively placed in the plurality of storage spaces.

Specifically, when moving a targeted cargo storage cage 323d to a desired (designated) location, the control part 350 preferably selects a plurality of cargo storage cages 323f to be moved including the targeted cargo storage cage 323d, and sequentially moves the selected plurality of cargo storage cages 323f to form idle space 301 while moving the targeted cargo storage cage 323d to the desired location 333d. The plurality of cargo storage cages 323f to be moved may be cargo storage cages already placed in the corresponding storage spaces 322.

As described above, when moving a targeted cargo storage cage to a desired location, the control part 350 may repeatedly perform a process of moving the plurality of cargo storage cages to create an empty storage space in an adjacent storage space in a movement direction of the targeted cargo storage cage, and moving the target cargo storage cage into the empty storage space.

In other words, when the control part 350 desires to move a specific cargo storage cage 323e moved to the location of the cargo entry/exit part 330 to a storage space 322d at a designated location (a desired location) during entry of a cargo storage cage but cargo storage cages 323f are already placed around the designated storage space 322d serving as obstacles, the specific cargo storage cage 323d located on the cargo entry side of the cargo entry/exit part 330 may not be able to move to the designated storage space 322d.

In this case, the control part 350 sequentially moves obstacle cargo storage cages 323f not only in the storage space 322d at the designated location, but also in the surrounding area of the storage space 322d, to another storage space 322f having idle space 301, to form the idle space 301 such that there are no other cargo storage cages 322 on the path along which the targeted specific cargo storage cage 323a passes and the location of the designated storage space 333d, thereby enabling the targeted specific cargo storage cage 323d to be moved to the location of the designated storage space 322d along a path without obstacles.

Meanwhile, as shown in FIG. 6, during entry of a cargo storage cage, the control part 350 according to an embodiment may move the cargo storage cage 323e located in the adjacent storage space 322e of the cargo entry part 330 to the cargo entry part 330 and then move the cargo storage cage 323e to the upper layer such that an empty cargo storage cage 323e is positioned at the position of the cargo entry part 330 to load (carry) cargo.

As described above, the reason for moving the cargo storage cage 323e in the adjacent storage space 322e to the cargo entry part 330 and then moving the cargo storage cage 323e to the upper layer is to secure free space for sequentially moving a plurality of cargo storage cages 323f through the empty adjacent storage space 322e, since each of the remaining storage spaces 322e except for the adjacent storage space 322e is already occupied by the cargo storage cage 323 loaded with corresponding cargo.

Meanwhile, cargo storage cages 323; 323f, etc. without an “x” mark as shown in FIG. 6 are cargo storage cages that are already loaded with cargo and are objects of movement, and cargo storage cages 323 with an “x” mark are cargo storage cages that are already placed in the storage spaces 322 but are not objects of movement.

Furthermore, during exit of a cargo storage cage as shown in FIG. 7, when moving a cargo storage cage 323g already placed in a storage space 322g having an arbitrary position to the location of the cargo entry/exit part 330, the control part 350 according to an embodiment may move a cargo storage cage 323h in a storage space 322h adjacent to the cargo entry/exit part 330 to the cargo entry/exit part 330 while sequentially moving a plurality of cargo storage cages 323i already present between the location of the already placed cargo storage cage 323g and the location of the entry/exit part 330, thereby forming idle space 302 therein and moving the already placed cargo storage cage 323g to the location of the cargo entry/exit part 330 through the path of the idle space 302.

In this case, when the control part 350 moves the already placed cargo storage cage 323g to the location of the entry/exit part 330, it is preferable to select a plurality of cargo storage cages 323i on the path through which the already placed cargo storage cage 323g passes as objects of movement, and sequentially move the selected plurality of cargo storage cages 323i to form idle space 302 while moving the already placed cargo storage cage 323g to the location of the entry/exit part 330.

In other words, when the control part 350 according to an embodiment desires to move a specific cargo storage cage 323g already placed in a specific storage space 322g to the location of the cargo entry/exit part 330 during exit of a cargo storage cage, assuming that other cargo storage cages 323i that serve as obstacles are already placed around the specific cargo storage cage 323g, the specific cargo storage cage 323g may not be movable to the location of the cargo entry/exit part 330 due to the other cargo storage cage 323i.

In this case, the control part 350 sequentially moves the other obstacle cargo storage cages 323i along the path formed as the idle space 301 to prevent the other cargo storage cages 323i from serving as obstacles on the path that the specific cargo storage cage 323g passes through, thereby enabling the specific cargo storage cage 323g to be moved to the exit side of the cargo entry/exit part 330 along the path without obstruction.

In this case, the cargo storage cages 323i serving as obstacles may also be sequentially moved through the idle space 302. This assumes the movement of a specific cargo storage cage 323g from the already arranged location to the exit side in the worst case, such as when the cargo storage cages 323 are already placed in the remaining storage spaces 322 except for the storage space 322h adjacent to the cargo entry/exit part 330 as shown in FIG. 7.

As described above, not only the targeted cargo storage cage 323d or 323g that sequentially moves during entry and exit of a cargo storage cage, but also the plurality of cargo storage cages 323f and 323i around the targeted cargo storage cages 323d and 323g may move by finding idle space on a designated path in a rotational manner, for example. However, the present disclosure is not limited thereto. In this case, the manner of rotation may be a manner of following the shortest distance.

As described above, when the corresponding cargo storage cages 323d and 323g are moved to the final destination locations during entry and exit of a cargo storage cage in the rotational manner, which is based on the shortest distance, the storage space 322h adjacent to the cargo entry/exit part 330 may be occupied by a cargo storage cage 323 loaded with (carrying) cargo last after placing cargo storage cages 323 loaded with (carrying) cargo in other storage spaces 322, under the control of the control part 350, and the cargo storage cage 323 loaded with (carrying) cargo last may be transmitted to the cargo entry/exit part 330 to be lifted to the upper layer, or in the case of exit of cargo, may be moved to the cargo entry/exit part 330 to be taken out.

As described above, the reason for transmitting the cargo storage cage 323 loaded with cargo last to the cargo entry/exit part 330 and lifting the cargo storage cage 323 loaded with cargo last to the upper layer is that the cargo storage cage 323 may not be placed in the remaining storage spaces 322 of the lower layer except for the storage space 322h adjacent to the cargo entry/exit part 330.

Meanwhile, when there is much idle space (free space) among the plurality of storage spaces 322, the control part 350 according to an embodiment may not move the cargo storage cages 323 already placed in the plurality of storage spaces 322 but move the cargo storage cage 323 loaded with cargo from the location of the entry/exit part 330 along a path (an arrow direction) of the empty idle space with the shortest distance to a target specific storage space 322, or conversely, may move the cargo storage cage 323 in the specific storage space 322 to the location of the entry/exit part 330 along a path of the idle space based on the shortest distance.

Meanwhile, the control part 350 described above may control the movement of the cargo storage cage 323 by controlling the rotation of the plurality of rollers 323A when the cargo storage cage 323 has the plurality of rollers 323A that enable backward, forward, left, and right movement along the rail 321.

In addition, as described above, the reason for moving a targeted cargo storage cage 322 loaded with cargo to a designated (desired) location as described throughout the present embodiment is to consider special circumstances, such as cargo being temperature-sensitive or significantly heavier compared to other cargo, allowing the storage location of the cargo storage cage 322 loaded with cargo to be determined.

This will be described below as an example, but the key point here is not the determination of the location of a designated cargo storage cage 322, but the ability to unload the corresponding cargo storage cage 323 at an arbitrary location while relocating the already placed cargo storage cages 323, which are obstacles on the path, through the shortest path within the limited storage space, and even when the cargo storage cage 323 loaded with (carrying) the received cargo is to be moved to a designated arbitrary location, the ability to relocate the already placed cargo storage cages 323 that are obstacles on the path through the shortest path, allowing the storage space utilization to be maximized.

Meanwhile, cargo storage cages 323; 323i, etc. without an “x” mark as shown in FIG. 7 are cargo storage cages that are already loaded with cargo and are objects of movement, and cargo storage cages 323 with an “x” mark are cargo storage cages that are already placed in the storage spaces 322 but are not objects of movement.

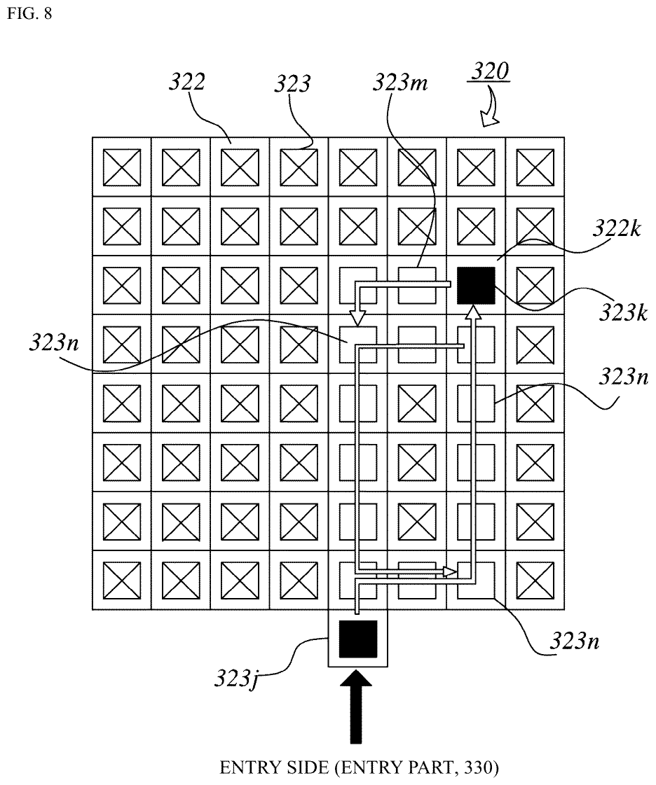

FIG. 8 is a diagram illustrating a state of a cargo storage cage that is an object of movement being moved in consideration of the weight of the cargo according to an embodiment of the present disclosure.

Referring to FIG. 8, the control part 350 according to an embodiment may control the movement of a cargo storage cage that is an object of movement based on the weight of cargo loaded into each cargo storage cage 323 already placed in a plurality of storage spaces 322 during entry of a cargo storage cage.

For example, as shown in FIG. 8, assuming that a first cargo storage cage 323j loaded with cargo received from the cargo entry/exit part 330 for the position 322k of row 3, column 7 in the storage space partition structure of 8 rows and 8 columns is placed at the position 322k of row 3, column 7, when the weight of cargo of a second cargo storage cage 323k to be moved, which is already placed at the position 322k of row 3, column 7, is significantly greater than the weight of cargo loaded on third cargo storage cages 323n (with no “x”) that are objects of movement, the movement of the second cargo storage cage 323k that is an object of movement may be reduced as much as possible, and only the third cargo storage cages 323n in a different row that are objects of movement may be moved first through sequential rotation, and when the first cargo storage cage 323j that will be moved later moves to an adjacent position, the second cargo storage cages 323k and 323m in the same row may be moved to the neighboring idle space, and the first cargo storage cage 323j moved to the adjacent position may finally be moved to the position of row 3, column 7.

Here, the rotation-type movement path (the arrow direction) is only an example of the shortest distance among the paths from the entry side to the position of row 3, column 7. Meanwhile, the cargo storage cages 323n, 323m, and 323k without the “x” mark shown in FIG. 8 indicate cargo storage cages that are objects of movement, and the cargo storage cages 323 marked with “x” indicate that it is already placed in the corresponding storage spaces 322.

As described above, in the present embodiment, the plurality of cargo storage cages that are objects of movement may be moved by selecting a method in which cargo storage cages in the idle space based on the minimum path from the current location of the targeted cargo storage to the desired location are moved through sequential rotation, or a method in which only some of the cargo storage cages 323n that are objects of movement may be moved sequentially based on the weight of cargo loaded on each cargo storage cage, and then the cargo storage cages 323k and 323m that are significantly heavy and are objects of movement may be moved to the neighboring location later, as described above, thereby diversifying the movement method of the plurality of cargo storage cages 323k and 323m that are objects of movement.

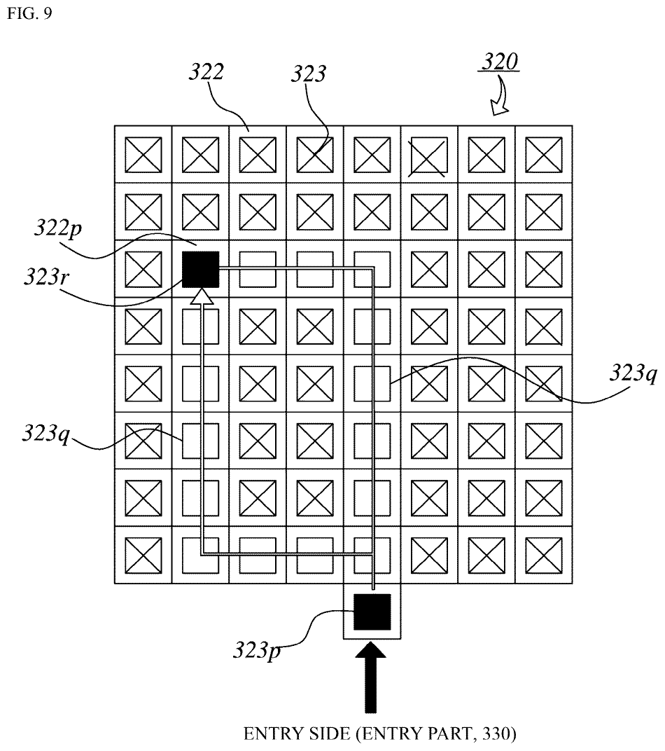

FIG. 9 is a diagram illustrating a process of determining the location of a cargo storage cage loaded with cargo in consideration of the temperature according to an embodiment of the present disclosure.

Referring to FIG. 9, the control part 350 according to an embodiment may move a first cargo storage cage 323p loaded with cargo received from the cargo entry/exit part 330 to the location of a designated arbitrary storage space 322 in consideration of the temperature characteristics of each compartmented storage space 322 and cargo loaded in the first cargo storage cage 323p.

For example, as in FIG. 9, the control part 350 may, in response to the first cargo storage cage 323p being loaded with highly temperature-sensitive cargo from the cargo entry/exit part 330, search for a storage space that matches the temperature characteristics of the cargo and determine the location in which the cargo is to be placed.

For example, the control part 350 may, upon determining the location 322p of row 3, column 2 as the location of a corresponding storage space 322p according to the temperature characteristics of the cargo, move the first cargo storage cage 323p loaded with the cargo received from the cargo entry/exit part 330 to the storage space 322p at the location of row 3, column 2.

To this end, the control part 350 may sequentially rotate a plurality of cargo storage cages 323q and 323r, which are pre-placed and are objects of movement, in the direction of the arrows to move the first cargo storage cage 323p to the storage space 322p at the location of row 3, column 2.

As described above, the present embodiment allows for long-term storage of temperature-sensitive cargo in a corresponding storage space that has a temperature environment that matches the temperature characteristics of the cargo, in consideration of the temperature characteristics of the cargo and the temperature characteristics of the storage space.

Here, the rotation-type movement path (arrow direction) is only an example of the shortest distance among the paths from the entry side to the location of row 3, column 2. Meanwhile, the cargo storage cages 323r and 323q without the “x” mark shown in FIG. 9 indicate cargo storage cages that are objects of movement, and the cargo storage cages 323 marked with the “x” mark indicate that it is already placed in the corresponding storage spaces 322.

In addition, the control part 350 in the present embodiment may determine the placement location (the storage space location) of the cargo storage cage 230 loaded with cargo in further consideration of various environmental characteristics and/or cargo characteristics, such as the weight of the cargo to be loaded and humidity. For example, the cargo deposited by the user may vary, and in particular, there may be cargo that is sensitive to temperature, humidity, and weight.

Meanwhile, the control part 350 in the present embodiment may use a detection sensor (not shown) to recognize the location of the corresponding storage space divided into a grid structure and whether the corresponding cargo storage cage is placed at the location.

That is, the control part 350 may detect, for example, whether the cargo storage cage 323 loaded with received cargo is located at the location of the designated storage space using the detection sensor, may determine the status of entry and/or exit based on the detected detection information, and may transmit the determined result to the entry/exit management apparatus 200. Accordingly, the manager who manages the entry/exit management apparatus 200 may easily manage the status of entry/exit.

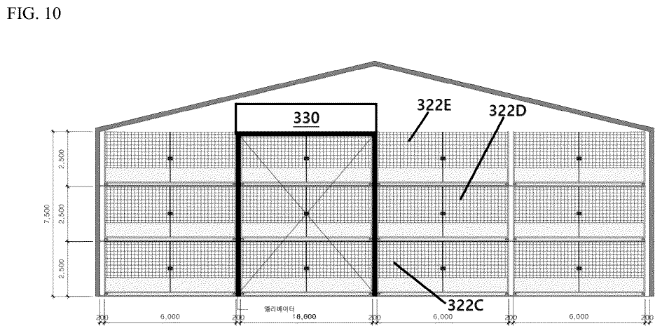

FIG. 10 is a schematic exemplary diagram illustrating the shape of a multi-layered storage space and a cargo entry/exit part according to an embodiment of the present disclosure.

The plurality of storage spaces 322 according to an embodiment may have, for example, storage spaces each having a three-layered storage space structure 322C, 322D, and 322E as in FIG. 10, unlike a plurality of storage space structures formed on the first layer as described above.

In this case, when the control part 350 moves the cargo storage cage 323 located in the storage space 322 adjacent to the cargo entry/exit part 330 (a cargo entry part and a cargo exit part) on the first floor to the cargo entry part 330, the cargo entry/exit part 330 illustrated in FIG. 10 may move the moved cargo storage cage 323 to a higher layer, such as the second or third floor.

The cargo entry/exit part 330 may have an elevator structure that may rise up to a 4th story height in the case of a three-layered storage structure 322C, 322D, and 322E as in FIG. 10.

Meanwhile, the functional operations performed by the control part 3500 of the above-described automated cargo storage apparatus 300 may be implemented as an automated cargo storage method. In this case, the automated cargo storage method may process the functional features operated by the control part 350 of the automated cargo storage apparatus 300 in stages.

The functional operations performed by the control part 350 according to various embodiments described above may be implemented in the form of program instructions and may be recorded on computer readable media.

The computer readable media may be provided with program instructions, data files, data structures, and the like alone or in combination. The program instructions recorded on the computer readable media may be specially designed and constructed for the purposes of the present disclosure or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a DVD, magneto-optical media such as a floptical disk, a ROM, a RAM, a flash memory, etc. The program instructions include not only machine language code made by a compiler but also high level code that may be used by an interpreter etc., which is executed by a computer. The hardware device may be configured to operate as one or more software modules to perform the operations of the embodiments, and vice versa.

As is apparent from the above, various embodiments are implemented to receive and unload desired cargo by freely moving already stored cargo through control for moving a cargo storage cage loaded with cargo to a storage space at a desired location through a cargo entry/exit part and moving a cargo storage cage placed in a storage space at an arbitrary location to the cargo entry/exit part.

Accordingly, various embodiments of the present disclosure are implemented to place or unload desired cargo at any time by fully utilizing a grid-shaped cargo storage space, which is a limited cargo storage space having no empty space without using the conventional device of transportation, such as a forklift.

In addition, various embodiments of the present disclosure are implemented to relocate a cargo storage cage already placed in an arbitrary storage space through a minimum path, move cargo stored in a target cargo storage cage to an exit side, and while relocating an already placed cargo storage cage through the minimum path, move a cargo storage cage loaded with cargo to the location of a desired storage space through the minimum path.

In addition, various embodiments of the present disclosure are implemented to find the location of an optimal storage space in consideration of the temperature characteristics of the storage space and the cargo to be loaded and/or the weight of the cargo to be loaded, and place the cargo storage cage carrying the cargo in the optimal storage space, thereby enhancing the preservation and safety of the cargo to be stored for a long time.

While the present disclosure has been shown and described with respect to particulars, such as specific components, embodiments, and drawings, the embodiments are used to aid in the understanding of the present disclosure rather than limiting the present disclosure, and those skilled in the art should appreciate that various changes and modifications are possible without departing from the spirit and scope of the invention.

Therefore, the spirit of the present disclosure is not defined by the embodiments, and the scope of the present disclosure is to cover not only the following claims but also all modifications and equivalents derived from the claims.

What is claimed is:

1. An automated cargo storage apparatus comprising:
a cargo storage part including a plurality of storage spaces arranged in a plurality of layers, each of the layers being divided into the plurality of storage spaces, each occupying a predetermined area on a plane along a rail arranged in a grid structure, a plurality of cargo storage cages loaded with cargo being placed in the plurality of storage spaces and movable forward, backward, leftward, and rightward along the rail, respectively;
a cargo entry/exit part protruding outward from one side of the cargo storage part and having an elevator structure that moves a cargo storage cage vertically in the elevator structure, the cargo storage cage being loaded or unloaded through the cargo entry/exit part; and
a control part configured to move a target cargo storage cage to a storage space at a specified location and control vertical movement of the cargo storage cage within the cargo entry/exit part,
wherein the cargo entry/exit part includes one more layer than a number of the layers in the cargo storage part, and
wherein the control part is configured to:
when unloading a first cargo storage cage located in a target layer, temporarily move a second cargo storage cage, placed in an adjacent storage space in the target layer, to an upper layer to create an empty storage space in the target layer, sequentially move the plurality of cargo storage cages in the target layer to position the first cargo storage cage in the storage space previously occupied by the second cargo storage cage, and unload the first cargo storage cage through the cargo entry/exit part.

2. The automated cargo storage apparatus of claim 1, wherein the control part is configured to, when moving a targeted cargo storage cage to a desired location, repeatedly perform a process of moving the plurality of cargo storage cages to create an empty storage space in an adjacent storage space in a movement direction of the targeted cargo storage cage, and moving the target cargo storage cage into the empty storage space.

3. The automated cargo storage apparatus of claim 2, wherein the control part is configured to, when moving the targeted cargo storage cage to the desired location, select a looped multiple storage spaces including a current location, the desired location, and the empty storage space, and sequentially moves the cargo storage cages located in the plurality of storage spaces to the looped multiple storage spaces to position the targeted cargo storage cage to the desired location.

4. The automated cargo storage apparatus of claim 3, wherein the selected multiple storage spaces are selected to have a minimum movement path from the current location of the targeted cargo storage cage to the desired location.

5. The automated cargo storage apparatus of claim 3, wherein the selected multiple storage spaces are selected based on weights of cargos loaded in the plurality of cargo storage cages respectively placed in the plurality of storage spaces.

6. The automated cargo storage apparatus of claim 1, wherein the rail includes a plurality of rotatable rollers to enable the cargo storage cages to move forward, backward, leftward, and rightward, and
wherein the control part is configured to control rotation of the plurality of rollers to control the movement of the targeted cargo storage cage.

7. The automated cargo storage apparatus of claim 1, wherein the cargo storage cages include a plurality of rotatable rollers to enable forward and backward and left and right movement to enable the cargo storage cages to move along the rail.

8. The automated cargo storage apparatus of claim 1, wherein the cargo entry/exit part includes a plurality of elevator parts that are movable upward or downward while carrying the cargo storage,
wherein the plurality of elevator parts is maintained while being stacked on the ground in an area where a cargo storage cage is loaded and unloaded,
wherein an upper elevator part, loaded with the second cargo storage cage, moves vertically to provide a movement space within the cargo entry/exit part, and a lower elevator part moves through the movement space to transport the first cargo storage cage to an entry/exit area.

9. The automated cargo storage apparatus of claim 8, wherein the plurality of elevator parts respectively includes rails connected to a rail formed in the cargo storage part and connected to a rail extending to outside through an entry/exit area.

10. The automated cargo storage apparatus of claim 1, wherein each of the plurality of storage spaces is fully occupied by the cargo storage cages, and during entry of a cargo storage cage, an empty cargo storage cage is preemptively unloaded to create an empty storage space.
